(19) United States
(12) Patent Application Publication
(10) Pub. No.: US 2011/0299988 A1
(43) Pub. Date: Dec. 8, 2011

(54) WATER WHEEL

(76) Inventor: Hermann Riegerbauer, Leibnitz (AT)

(21) Appl. No.: 13/138,435

(22) PCT Filed: Feb. 24, 2010
(86) PCT No.: PCT/EP2010/001130

§ 371 Date: Aug. 18, 2011

(30) Foreign Application Priority Data
Feb. 25, 2009 (AT) A 313/2009

(51) Int. Cl. F03B 7/00

(52) U.S. Cl. 416/178

(57) ABSTRACT

The invention relates to a water wheel, preferably an undershot or breast-shot water wheel having a horizontal hub (21), wherein paddle arrangements (15) are provided along the wheel circumference (22) for converting the kinetic and optionally also potential energy of the water stream into a rotational motion of the water wheel, wherein the paddle arrangements (15) comprise at least two paddle blades and the paddle blades have different sizes, characterized in that the outer paddle blade (13) has a greater depth (23) than the further inner paddle blades (14, 16, 17) of the paddle arrangement. The invention further relates to a hydroelectric power plant comprising one or a plurality of such water wheels.

The invention concerns a water wheel, preferably an undershot or breastshot water wheel with horizontal hub, wherein for the purpose of converting the kinetic and possibly also the potential energy of the water flow into a rotary movement of the water wheel paddle arrangements are provided along the periphery of the wheel, wherein the paddle arrangements comprise at least two paddle blades and the paddle blades are of different size.

Water wheels have been used for a very long time. Such water wheels are used in particular used for the energy supply of mills and hammer mills. Both undershot and overshot water wheels have been set up only for relatively low rotational speeds and the utilisation of the energy of the water has been deficient. Consequently the technical development of such water wheels has come to an end to a large degree, since by developing turbines of various types great efficiency and also great numbers of revolutions could be achieved, which as a consequence made the generation of electric current logical from the economic point of view.

However, there is a constant and even increasing demand for small power plants, which make power generation possible even with limited intrusion in the natural flow of the water, so that a further development of water wheels makes now sense again.

Known undershot and breastshot water wheels have predominantly single-piece continuous blades which, however, as far as flow conditions are concerned, are unfavourable. Energy is lost when the blades immerse into the water flow as well as when they emerge from the water flow, whereby volumes of water are uselessly displaced or lifted. By virtue of this the degree of efficiency is greatly reduced and the achievable rotational speed is also low. When the continuous blades are closed towards the hub an additional suction effect occurs during the running off of the water, that further restrains the water wheel.

To overcome this disadvantage AT 503 184 A1 suggests that each paddle arrangement comprises an outside and at least one inside paddle blade and the inside paddle blades are offset inward from the periphery of the wheel and against the direction of the water flow.

It became obvious from the practice, that despite the stated advantages of the water wheel mentioned, the degree of efficiency is not yet at its optimum. According to the state-of-the-art the water flow, impacting the paddle arrangements, transfers only a portion of its kinetic energy on to the water wheel and a portion of the water flow runs through the blades of the paddle arrangements without delivering its kinetic energy.

Thus it is the object of this invention to provide a water wheel which has a greater degree of efficiency than hitherto known ones.

According to the invention this objective is achieved by that the depth of the blade of the outermost paddle blade is greater than that of the other inside paddle blades of the paddle arrangement. Further features can be obtained from the patent claims, the description and the drawings.

Further advantageous features are that the paddle depth of the inside paddle blades of a paddle arrangement increases from the periphery of the wheel towards the inside, that the paddle blades of a paddle arrangement are offset from the periphery of the wheel inwards and against to the direction of the water flow and that the paddle arrangements have an inward narrowing construction. In an advantageous manner the paddle blades can be arranged at inward reducing distances from one another. Preferably every paddle blade is curved, while the convex curvatures are directed in the direction of rotation of the water wheel.

Further features are that the paddle depth of the outermost paddle blade, having the greatest paddle depth, is at least twice the depth of the water flow. The inside ends of the outermost paddle blades can be arranged in the direction of the wheel hub of the water wheel. Alternatively, the inside ends of the outermost ends of the outermost paddle blades can be inclined against the oncoming flow and thus curved away from the radial alignment. The tangents to the outer ends of the paddle blades enclose with the tangent to the periphery of the wheel an angle of 45°±5°. The water wheel is further characterised in that the inside positioned paddle blades and possibly also the outermost paddle blade have an airfoil-like cross-section and are so arranged, that between the adjacent paddle blades narrowing flow channels are formed for the water.

A hydraulic power plant can be constructed by that at least one water wheel has at least some of these features.

The arrangement of the water wheel with horizontal hub means that the individual paddle blades between the vertically wheel side plates are also essentially horizontally positioned, although within the scope of the invention the paddle blades are also positioned inclined relative the wheel side plates or may have a form that deviates from the straight line. The outer paddle blades are those which are provided nearest to the periphery of the wheel or are provided directly on the periphery of the wheel. The inside paddle blades are those which have a smaller or the smallest radial distance from the hub.

The water depth mentioned at any time is that depth of the water flow which allows an optimal operation of the water wheel and for which the water wheel is designed.

The high rotational speed of the water wheel, resulting from the invention, allows a greater immersion depth of the water wheel in the water behind it. The waterfall drop at the inlet of the wheel increases to the same degree as the depth of the immersion of the wheel.

A quiet running condition can be also achieved by that the intermediate space between the wheel side plates is divided and correspondingly shortened blades are provided between them offset on the periphery. Thus the water wheel can also have the feature that it is formed by joining two water wheels to become one single water wheel having three wheel side plates and that in their rotational position the paddle arrangements of both water wheel halves are offset relative one another.

The utilisation of the water wheel according to the invention can make also sense when instead of the optimum water flow depth a too small or a somewhat to great water depth is present.

The invention is described in detail in the following based on embodiments.

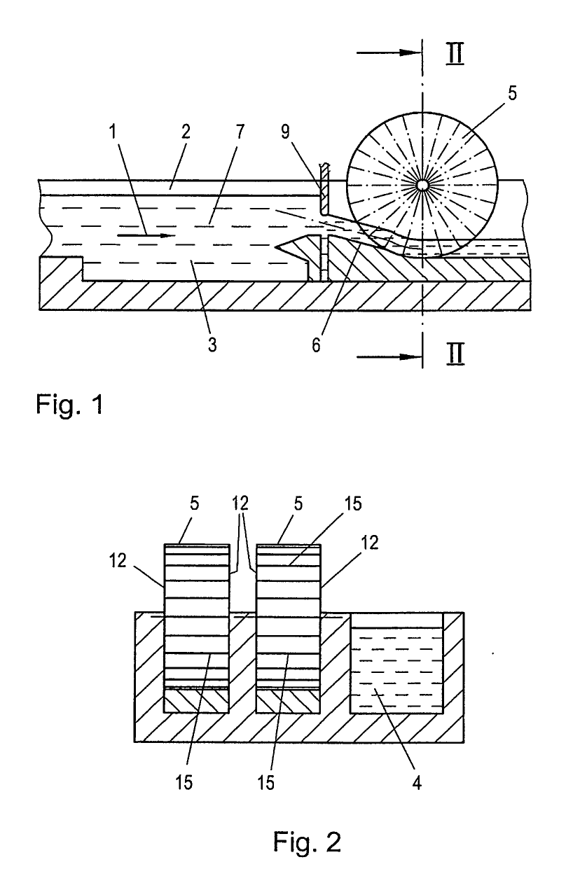

FIG. 1 is a section through a hydraulic power plant and

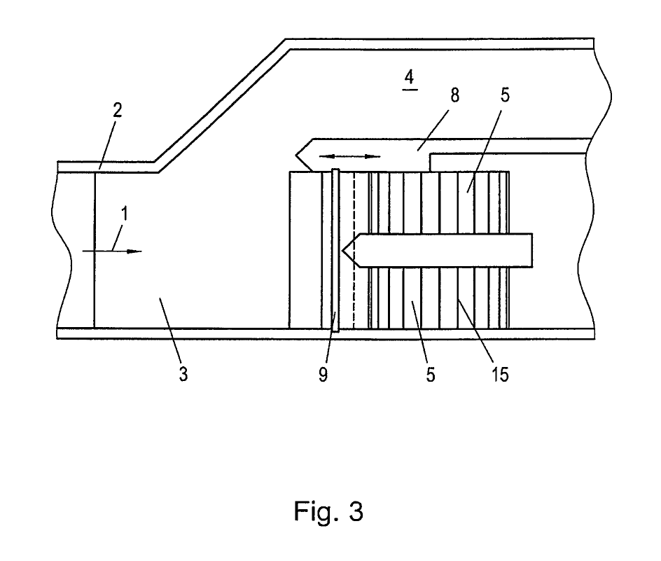

FIG. 2 is a section according to line II-II of FIG. 1.

FIG. 3 is a top view on this hydraulic power plant.

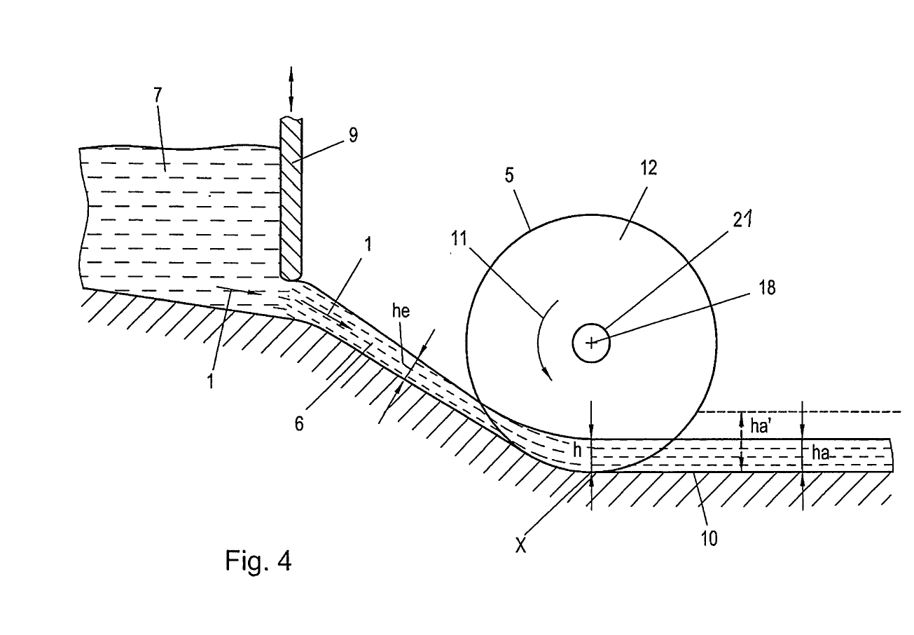

FIG. 4 schematically shows the flow conditions on the water wheel and

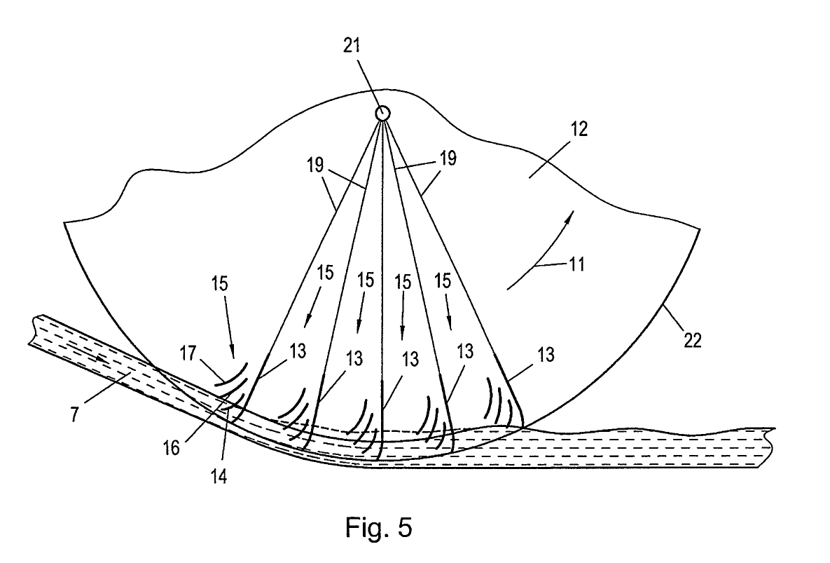

FIG. 5 shows schematically the arrangement of the paddle blades between the side plates of the water wheel.

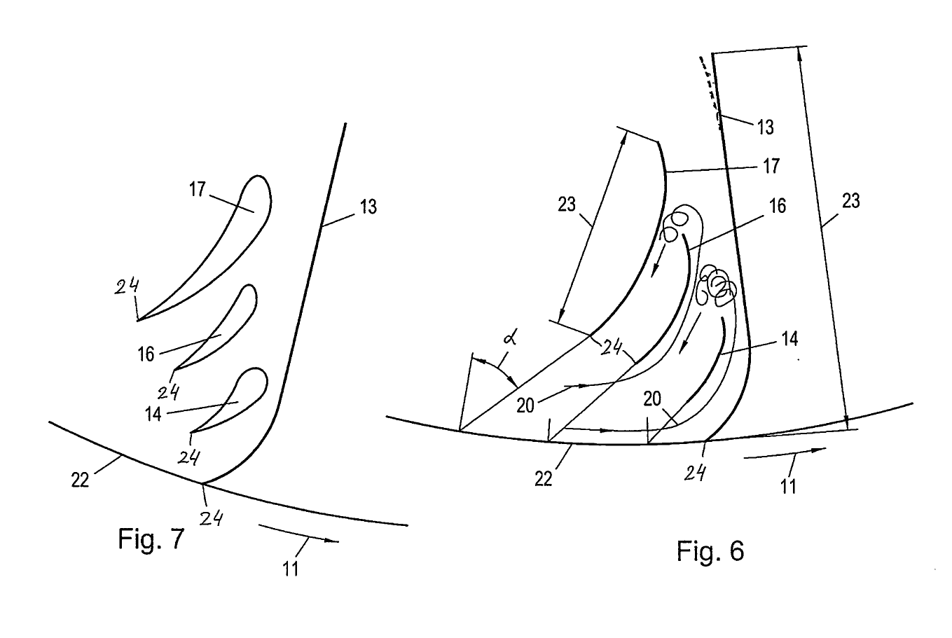

FIGS. 6 and 7 show details of two examples of the arrangement of the paddle blades of a paddle arrangement.

FIGS. 1 and 3 schematically show a power plant. The water flows in the direction of the flow 1 in the water inflow channel 2, that has a sediment tank 3. An overflow channel 4 is provided to accommodate the excess water or guide the entire water flow past the water wheels 5 by means of a weir 8, 9. In this current example two water wheels are arranged adjacent to one another. However, a single water wheels may also be provided or a plurality of water wheel next to one another.

The paddle arrangements 15 between the respective wheel side plates 12 are only schematically indicated by straight lines.

The water channel has, in a manner known per se, an accelerating section 6, that at the water inlet promotes an increase of the height of the bottom and a subsequent falling section for the water outflow and serves the purpose of increasing the flow velocity as well as the generation of a defined water flow.

FIG. 3 shows the schematic top view on this power plant, while the associated weirs 8, 9 are schematically shown only.

FIG. 4 schematically shows the water flow, while the height conditions and steps in the flow section are not to scale.

The inlet water depth of the water flow in the water inlet channel is he, that decreases along the accelerating section 6 and results in the water flow depth h, that represents the effective water flow exerting its force on the water wheel. Each water wheel has a water flow depth that is optimal for the work of the water wheel and for which the water wheel is dimensioned.

After flowing through the water wheel the water flows out through the water outlet 10, while it is advantageous if the outflow water depth ha is not below the water flow depth h. Due to the rotational movement of the water wheel in the direction of rotation 11 about the axis of rotation 18 and the hub 21 in most cases a damming up of the outflowing water will occur, due to which the outflowing water depth ha may be greater than the water flow depth h, as this is indicated by a dot-dash line at ha′.

The weir 9, illustrated in FIGS. 1 and 4, defines the depth of the water flow and is preferably height adjustable for this purpose. When the weir 9 is fully lowered, the water inflow is closed off, consequently the water wheel is drained and can be serviced.

FIG. 5 schematically and partially shows a cross-section through the water wheel according to the invention, as it interacts with the inflowing water flow 7. The wheel is illustrated only over a small portion of its wheel periphery 22 and of the paddle arrangements 15 provided along the entire periphery of the water wheel only five paddle arrangements are shown, which in the drawing are in contact with the water.

Each paddle arrangement 15 has an outermost paddle blade 13, that has a greater paddle depth 23 (see FIG. 6) than the other paddle blades 14, 16 and 17. The number of the inside paddle blades 14, 16 17 can be customised to suit the conditions, whereby at least one or several inside paddle blades may be provided. The lines 19 leading towards the wheel hub 21 are only constructive auxiliary lines and elucidate in this embodiment the orientation of the outermost paddle blades 13 in the direction of the hub 21 of the water wheel.

Alternatively, it may be advantageous to construct the inside edge of the outermost paddle blade 13 inclined against the direction of inflow 1 (shown in broken line in FIG. 6), so that the distances of the inside edges of the inside paddle blades 14, 16, 17 to the outermost paddle blade 13 can be accommodated to suit the flow conditions. All paddle arrangements are open towards the inside, so that enclosed chambers, which could disadvantageously take up water and hinder its outflow, are precluded.

The wheel side plates 12 may have full-area construction, between which the paddle arrangements are situated. However, other side plate constructions may also be provided, like for example braced constructions that are laterally not fully enclosed. A further embodiment may be such where only one central wheel plate is provided on the wheel hub 22, the paddle arrangements extending outward from both of its sides.

FIGS. 6 and 7 show on an enlarged scale the arrangement of the paddle blades within the paddle arrangement in two versions.

According to FIG. 6 all paddle blades 13, 14, 16, 17 are bent from a material of the same thickness, while the convex curvatures are directed towards the direction of rotation 11. The progress of the flow of the incoming water is also indicated in FIG. 6 by flow lines 20. Due to the curved construction of the adjacent blades and the constrictions caused by this fact after flowing through the blade arrangement turbulences of the inflowing water occur, preventing an upsurge of the water over the entire paddle depth of the outermost paddle blade 13. This will ensure that the entire kinetic energy of the inflowing water is transformed into the rotary movement of the water wheel. It will further ensure that the water flowing in can flow out again from the paddle arrangement through the shortest path and thus will not hinder the rotational movement.

To achieve the effect according to the invention basically only the first inside situated paddle blade 14 is required. However, the additional inside situated paddle blades 16 and 17 can reinforce the effect.

FIG. 7 shows a further embodiment with an illustration similar to that of FIG. 6, wherein the inside situated paddle blades 14, 16 and 17 have airfoil-like cross-section. In this case too a narrowing flow channel results between the adjacent blades with the desired effect of turbulence after passing through of the water and the effect of rapid outflow of the water when the paddle arrangement is lifted from the water flow.

The outermost paddle blade 13 may also have an airfoil-like cross-section, just like the inside paddle blades 14, 16, 17 of FIG. 7. On the external edges 24 the blades are at an angle α of approx. 45° to the tangent of the wheel periphery 22, as this is illustrated in FIG. 6 by auxiliary lines. Advantageously the range of the angle is 45°±5°.

The effect of the paddle arrangement according to the invention is particularly characterised in that the flow velocity of the water is converted almost without any loss into circumferential speed of the water wheel and consequently a high rotational speed. Such water wheels are therefore energy efficient and, in addition, can be manufactured at lower cost.

The paddle depth 23 of the outermost paddle blade 13 depends on the depth of the inflowing water. The depth is at least twice the depth of the water he and has to be at least such that the inflowing water cannot flow over the inside edges of the outermost paddle blades.

The paddle arrangement according to the invention has also the advantage that an efficient utilisation of the water and a constant degree of efficiency is ensured even when the actual water level is above or below the line of the optimum water level. By virtue of the outermost paddle blade 13 with the greatest paddle depth 23 it will be ensured that the water cannot flow through the water wheel without being utilised. The inflowing water first fills the outermost paddle blade since this immerses first into the water. The inflowing water rises high between the paddle blades and in the region of the inside ends of the paddle blades the inflowing water becomes turbulent and deflected against the direction of flow. Consequently, the water further flowing in between the blades is impeded, so that the flow energy is transferred to the water wheel. A further effect is achieved by that between the rising water streams of the paddle blades and the water flowing from the inside towards the outside the air present there is entrapped and compressed. This will contribute to the increase of the service life of the water wheel and in an advantageous manner oxygen of the air will be increasingly brought into the water.

Paddle arrangements of small size require a stabilisation of the paddle blades. This can be achieved, for example, by bracings (not illustrated) between the paddle blades, while the number of braces can be chosen to suit the requirements.

The preferred material for the water wheel is steel. However, components of the water wheel may be made from aluminium alloys, timber and plastics.

### LIST OF REFERENCE NUMERALS

1 Direction of flow
2 Water inflow channel
3 Sediment tank
4 Overflow channel
5 Water wheel
6 Accelerating section
7 Water
8 Weir
9 Weir
10 Water outlet
11 Direction of rotation
12 Wheel side plate
13 Outermost paddle blade
14 Blade
15 Paddle arrangement
16 Blade
17 Blade
18 Axis of rotation
19 Lines
20 Flow line
21 Wheel hub
22 Wheel periphery
23 Paddle depth
24 Edge
he Depth of inflowing water
h Depth of water flow
ha, ha′ Depth of outflowing water
X′ Bottom point
α Angle

1: Water wheel, preferably an undershot or breastshot water wheel with horizontal wheel hub (21), wherein for the purpose of converting the kinetic and possibly also the potential energy of the water flow into a rotary movement of the water wheel paddle arrangements (15) are provided along the periphery (22) of the wheel, wherein the paddle arrangements (15) comprise at least two paddle blades and the paddle blades are of different size, wherein the depth (23) of the blade of the outermost paddle blade (13) is greater than that of the other inside paddle blades (14, 16, 17) of the paddle arrangement.

2: Water wheel according to claim 1, wherein the paddle depth (23) of the inside paddle blades of a paddle arrangement (15) increases from the periphery (22) of the wheel towards the inside.

3: Water wheel according to claim 1, wherein the paddle blades (13, 14, 16, 17) of a paddle arrangement (15) are offset from the periphery (22) of the wheel inwards and against to the direction of the water flow.

4: Water wheel according to claim 1, wherein the paddle arrangements (15) have an inward narrowing construction.

5: Water wheel according to claim 1, wherein the paddle blades (13, 14, 16, 17) are arranged at inward reducing distances from one another.

6: Water wheel according to claim 1, wherein every paddle blade (13, 14, 16, 17) is curved, while the convex curvatures are directed in the direction of rotation (11) of the water wheel.

7: Water wheel according to claim 1, wherein the paddle depth of the outermost paddle blade (13), having the greatest paddle depth (23), is at least twice the depth (h) of the water flow.

8: Water wheel according to claim 1, wherein the inside ends of the outermost paddle blades (13) are arranged in the direction of the wheel hub (21) of the water wheel.

9: Water wheel according to claim 1, wherein the inside ends of the outermost ends of the outermost paddle blades (13) are inclined against the oncoming flow (1) and thus curved away from the radial alignment.

10: Water wheel according to claim 1, wherein the tangents to the outer ends (24) of the paddle blades enclose with the tangent to the periphery (22) of the wheel an angle (a) of 45°±5°.

11: Water wheel according to claim 1, wherein the inside positioned paddle blades (14, 16, 17) and possibly also the outermost paddle blade (13) have an airfoil-like cross-section and are so arranged, that between the adjacent paddle blades (14, 16, 17) narrowing flow channels are formed for the water.

12. Hydraulic power plant, wherein it has one or several water wheels according to claim 1.
